(19) United States
(12) Patent Application Publication
(10) Pub. No.: US 2006/0208896 A1
(43) Pub. Date: Sep. 21, 2006

(54) Use of radio frequency identification for coupling input and output modules

(76) Inventor: Robert C. Mason, Wake Forest, NC (US)

Correspondence Address: SQUARE D COMPANY;LEGAL DEPARTMENT - I.P. GROUP, 1415 SOUTH ROSELLE ROAD, PALATINE, IL, 60067, US

(21) Appl. No.: 11/072,889

(22) Filed: Mar. 4, 2005

(51) Int. Cl. G08B 13/14; H04B 3/36; G08B 1/08

(52) U.S. Cl. 340/572.7; 340/539.1; 455/7

(57) ABSTRACT

A system, device, and method are disclosed for wirelessly coupling an input or output module to an industrial control equipment. The system includes a radio frequency identification (RFID) unit located at the input or output module for communication therewith, and also includes at least one antenna at the industrial control equipment, for communicating with the RFID unit. The RFID unit acts as an intermediary for communication between the control equipment and the input or output module.

### TECHNICAL FIELD

The present invention relates to Radio Frequency Identification (RFID) technology, and more particularly to RFID technology used in conjunction with input and output modules of industrial control equipment.

### BACKGROUND OF THE INVENTION

RFID technology has become well-known over the past few decades, and its potentialities continue to be expanded and exploited. Implementing an RFID device has certain basic features.

The simplest RFID device is the TAG. The tag is typically a completely passive device in that it contains no internal power source; it derives its operating power from the RF field used to interrogate the tag. A passive RFID Tag 100 is shown as a block diagram in FIG. 1.

The tag's only link to the outside world is normally the antenna 110, shown in FIG. 1 with connections LA and LB. When the antenna picks up an RF field of the proper amplitude and frequency, an operating voltage is generated that can power 120 the tag. The demodulator 130 extracts commands and data from the RF field and passes them along. The digital control block 140 interprets the received commands and data and formats responses. Tag responses are encoded and transmitted by the modulator 150. The memory block 160 stores received data and supplies data for responses. Since the operating voltage comes from the RF field, the contents of a volatile memory are lost when the field is not present. Non-volatile memory contents are maintained even in the absence of an RF field.

This tag architecture is described herein as a passive RFID device, wherein the entire data module is completely passive. As mentioned, the tag's only link to the outside world is normally the antenna, which is true for commercially available tags.

An active device is used in order to read from or write to a passive tag. This active device is commonly known as a reader/writer. The reader/writer generates the RF field that powers the tag. The reader/writer formats and transmits commands to the tag and receives responses back from the tag. FIG. 2 shows the block diagram of a reader/writer 200.

A higher-level device such as a computer or embedded micro-controller (the host system 210) controls operation of the reader/writer, which utilizes an RF board. In effect, the reader/writer is a kind of modem or transceiver that interfaces between the host system 210 and the RFID tag. Typically the reader/writer does no processing of the data passing between the RFID tag and the host system; it merely passes data between the two. With these two devices (i.e. the tag and reader/writer), systems can be built. The simplest system 300 consists of a host system 210, a reader/writer 200, and a tag 100, as shown in FIG. 3.

It is known in the art that an RFID device can be powered by a selectively engageable voltage source. Therefore, an RFID device can include an active transponder, instead of a transponder which relies on magnetic coupling for power. Thus, the RFID device can be given a much greater range. See O'Toole et al. (U.S. Pat. No. 6,735,183) which is incorporated herein by reference. However, this idea has merely been exploited to increase RFID range, and has not been used to deal with problems that arise when I/O modules are plugged into industrial control equipment such as a programmable logic controller (PLC).

A programmable logic controller, also called a programmable controller, is a computer-type device used to control equipment in an industrial facility. The kinds of equipment that PLCs can control are as varied as industrial facilities themselves. Conveyor systems, food processing machinery, auto assembly lines are just some examples of instances where there is probably a PLC in control. In a traditional industrial control system, all control devices were wired directly to the controlled device. In a PLC system, however, the PLC replaces the wiring between the devices. Thus, instead of being wired directly to each other, all field devices are wired to the PLC. Then, the control program inside the PLC provides the connection between the devices, and this control program is the computer program stored in the PLC's memory. The use of a PLC to provide wiring connections between system devices is called softwiring. For example, suppose a push button controls the operation of a motor; in a traditional control system, the push button would be wired directly to the motor. In a PLC system, however, both the push button and the motor would be wired to the PLC instead. Then, the PLC's control program would complete the electrical circuit between the two, allowing the button to control the motor. The softwiring advantage provided by programmable controllers is one of the most important features of PLCs. Softwiring makes changes in the control system easy and inexpensive. If one desires that a device in a PLC system behave differently or control a different process element, it is merely necessary to change the control program. In a traditional system, making this type of change would involve physically changing the wiring between the devices, which is typically a costly and time-consuming endeavor.

A PLC typically includes two basic elements: a central processing unit (CPU), and an input/output system. The CPU is the part of a programmable controller that retrieves, decodes, stores, and processes information. It also executes the control program stored in the PLC's memory. It functions much the same way the CPU of a regular computer does, except that it uses special instructions and coding to perform its functions. The CPU typically includes three basic parts: the processor, the memory system, and the power supply. The processor is the section of the CPU that codes, decodes, and computes data. The memory system is the section of the CPU that stores both the control program and data from the equipment connected to the PLC. The power supply is the section that provides the PLC with the voltage and current it needs to operate.

The input/output (I/O) system of a PLC is where all of the field devices are connected. The I/O system is what actually physically carries out the control commands from the program stored in the PLC's memory. The I/O system typically consists of two main parts: a rack, and I/O modules. The rack is an enclosure with slots, and the rack is connected to the CPU. I/O modules are devices with connection terminals to which the field devices are wired. Together, the rack and the I/O modules form the interface between the field devices and the PLC. When set up properly, each I/O module is both securely wired to its corresponding field devices and securely installed in a slot in the rack. This creates the physical connection between the field equipment and the PLC. In some small PLCs, the rack and the I/O modules come prepackaged as one unit. A rack backplane can provide signal buses and connectors for electrically coupling the modules. The structure and operation of I/O modules is well known by persons skilled in the art, and further detail can be found, for example, in Struger et al. (U.S. Pat. No. 4,250,563) and Gibart (U.S. Pat. No. 5,274,781), which are incorporated by reference herein.

All of the field devices connected to a PLC can be classified in one of two categories: inputs and outputs. Inputs are devices that supply a signal/data to a PLC. Typical examples of inputs are push buttons, switches, and measurement devices. Outputs are devices that await a signal/data from the PLC to perform their control functions. Lights, horns, motors, and valves are all good examples of output devices.

An overhead light fixture and its corresponding wall switch are good examples of everyday inputs and outputs. The wall switch is an input—it provides a signal for the light to turn on. The overhead light is an output—it waits until the switch sends a signal before it turns on.

There are two basic types of input and output devices: discrete and analog. Discrete devices are inputs and outputs that have only two states: on and off. As a result, they send/receive simple signals to/from a PLC. Analog devices are inputs and outputs that can have an infinite number of states. These devices can not only be on and off, but they can also be barely on, almost totally on, not quite off, et cetera. These devices send/receive complex signals to/from a PLC.

Because different input and output devices send different kinds of signals, they sometimes have difficulty communicating with the PLC. While PLCs are powerful devices, they cannot always speak the “language” of every device connected to them. That is where the I/O modules are particularly useful. The modules act as translators between the field devices and the PLC. They ensure that the PLC and the field devices all get the information they need in a language that they can understand.

PLCs generally use two basic types of instructions: contacts and coils. A contact is a computer code that monitors the status of an input. A coil is a computer code that monitors the status of an output.

Each contact in the control program monitors a certain field device. The contact waits for the input to do something in particular (e.g., turn on, turn off). Then, the contact tells the PLC's control program that an input device just did what it is supposed to do, and so the PLC should check and see if any of the output devices should be affected.

Coils are instructions that refer to the outputs of the control program—that is, to what each particular output device is supposed to do in the system. Like a contact, each coil also monitors a certain field device. However, unlike a contact, which monitors the field device and then tells the PLC what to do, a coil monitors the PLC control program and then tells the field device what to do.

In conventional expandable industrial control equipment, such as PLCs, there are connectors (e.g. in a rack) into which any additional input and output (I/O) modules are plugged. These exposed connectors are vulnerable to mechanical and electrical damage that can negatively impact not just the interface between a PLC and field devices, but can also cause damage to the PLC and field devices. The connector of the module itself must be carefully designed to prevent incorrect mating of the connectors, and even carefully designed connectors can cause damage when improperly used.

### SUMMARY OF THE INVENTION

According to this invention, a system, device, and method enable an input or output module to be wirelessly coupled to an industrial control equipment. The system includes a radio frequency identification (RFID) unit located at the input or output module for communication therewith, and also includes at least one antenna at the industrial control equipment, for communicating with the RFID unit. The RFID unit acts as an intermediary for communication between the control equipment and the input or output module.

RFID technology can be used to implement input/output (I/O) expansion. While RFID systems can be set up to operate at many different frequencies and at varying distances from the antenna, this invention disclosure will concentrate primarily on an embodiment that operates on the principle of proximity coupling, so that each RFID unit is close to its respective antenna, and therefore each antenna need not distinguish between RFID units. If the RF operating frequency of a proximity coupling system is chosen well, all components of the system, including the antenna, can be integrated into a single printed wiring board. The antenna itself can be implemented as a set of traces on the printed wiring boards; the antenna does not have to be a separate component.

Using RFID technology, the main or controlling module is designed to have an array of at least one small RF antenna. Each antenna supports one I/O module when the module is placed in close proximity to that antenna. There are no exposed connectors to mate. There are no connector alignment issues. As long as the two antennas share the RF field, the two modules are able to communicate with each other. Simple slots or brackets are all that are necessary to hold an I/O module in place at its intended antenna. The RF circuitry in the I/O module receives its power from the RF field, or alternatively it is powered from the I/O circuit voltage.

An alternative method is for the main module to have one large antenna whose field covers the entire area into which the I/O modules may be placed. The I/O modules then can have unique identifiers so that each module receives only the commands intended for it. In this case, a system is feasible wherein the I/O modules are not even physically attached to the main module. Distances of one meter or more between units are acceptable.

As mentioned, an RFID tag's only link to the outside world is the antenna, for commercially available tags. However, there is no reason to be confined in that way. The signals out of the Digital Control section of the tag block diagram could be fed into other devices. Those devices could have their own source of power or they could take power from the RF field. In either case, commands and data from the RF field would control those devices, too. This allows using RFID technology with many different types of communications and control devices.

### BRIEF DESCRIPTION OF THE DRAWINGS

FIG. 1 shows a prior art RFID tag.

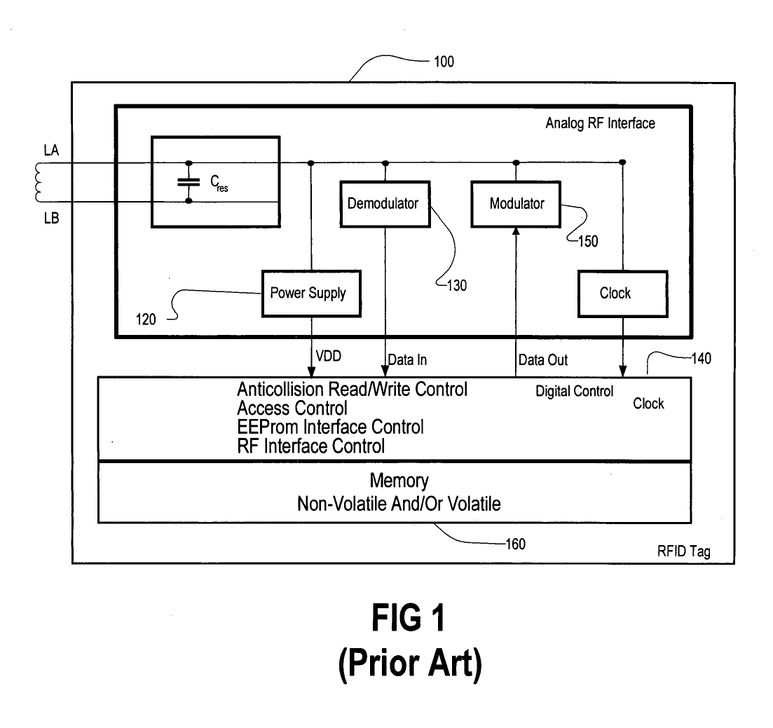

FIG. 2 shows a prior art reader/writer.

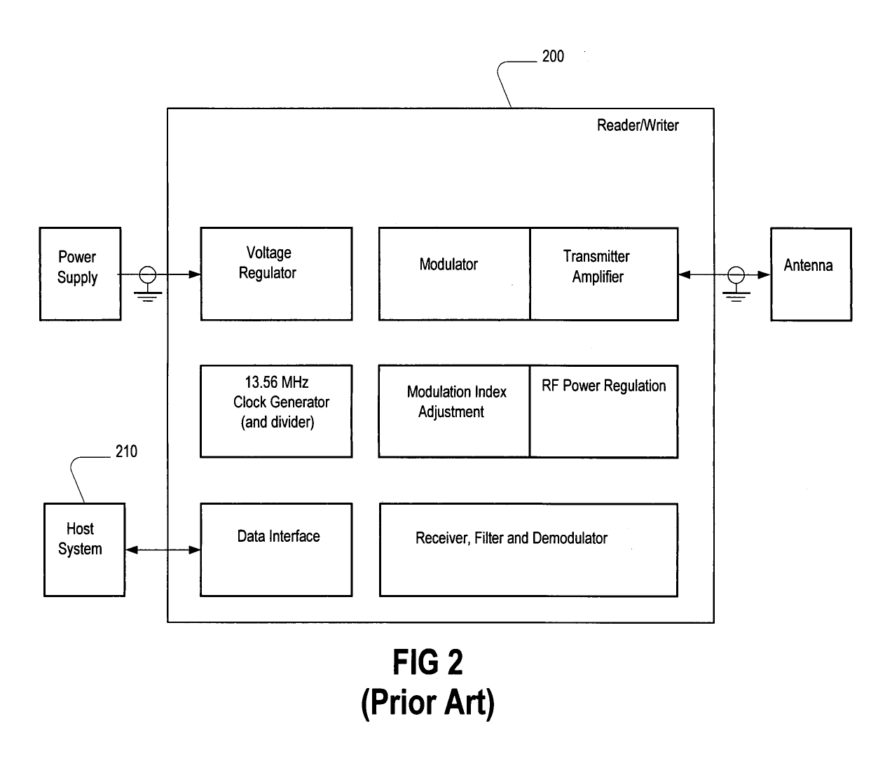

FIG. 3 shows a prior art system utilizing an RFID tag and reader/writer.

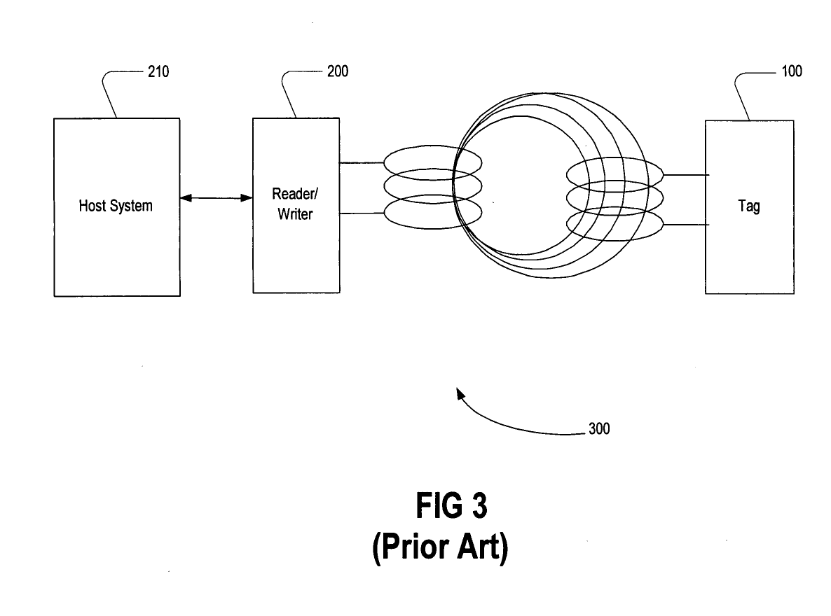

FIG. 4 shows a system in which a plurality of I/O modules are wirelessly coupled to a programmable logic controller using distinct RF fields.

FIG. 5 shows an expanded piece of industrial control equipment including I/O modules that have RFID tags.

FIG. 6 is a flow chart illustrating a method according to a simple embodiment of the present invention.

FIG. 7 shows a system in which a plurality of I/O modules are wirelessly coupled to a programmable logic controller using a single RF field without a backplane.

### BEST MODE FOR CARRYING OUT THE INVENTION

Traditional radio methods may superficially appear to be similar to the concept of the present invention. Infrared, on the other hand, would not be at all comparable because it is limited by line-of-sight issues as well as performance problems caused by the often-dirty industrial environment.

At the top level, traditional radio methods differ from the present invention by the frequency of the signals, which is a very significant difference. The lower frequencies of traditional radio require large antennas that are difficult to fit into electronic packaging. RFID antennas, by comparison, take up about 1 square inch of printed wiring board (PWB) area. The nature of the RF field makes it very selective as to what devices will be affected by it. Unless an antenna is placed in close proximity to the transmitter (e.g. only a fraction of a centimeter away) it will not detect or respond to the signal. This makes RFID much more selective than traditional radio transmission.

In some cases, the RFID equipment of the present invention will need more power than can reasonably be extracted from the RF field. In those cases, the RFID approach is still advantageous because of economy and simplicity, in addition to advantages already mentioned. It is not uncommon for I/O modules to have separate power sources to power the output or the power that is present on the input. These sources can be tapped to provide the additional power. In a traditional I/O module, this is not done so that the system communications are protected from transients; however, the present invention solves this problem through the electrical isolation of the RFID tag.

Some embodiments of the present invention call for powering at least part of the system from the RF field. For example, as already stated, the RF circuitry in the I/O module would receive its power from the RF field or it could be powered from the I/O circuit voltage. For the case of low power input modules, the RF field may be adequate to supply sufficient power to operate the whole module, and not just the RFID tag. One example is a thermocouple input. For that case, RFID gives the advantages of size, cost and simplicity.

The concept envisioned and disclosed here is a piece of equipment with an embedded RFID communications means. The design of the equipment would be such that the enclosures, housings, mounting means, and the like would align the RFID antennas and allow communications. Some of the advantages of this concept would be eliminating points of potential failure (connectors are notorious for failing due to dirt, corrosion, wear, and the like), simplifying assembly (no connectors to line up and seat), eliminating the possibility of mismatched connectors or reversing polarity of signals and, of course, galvanic isolation. Isolation is a major concern in industrial controls. Struger (U.S. Pat. No. 4,250,563) gives not only a good description of how I/O modules work in a PLC, but also includes illustrations of the rack and I/O connectors that the present embodiment replaces.

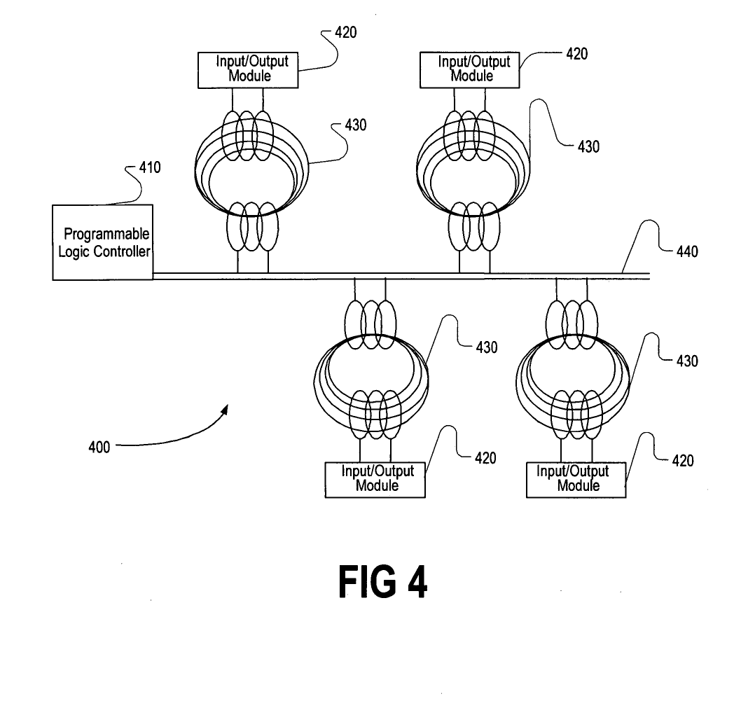

As seen in FIG. 4, a system 400 includes the industrial control equipment 410 such as a programmable logic controller (PLC). The PLC can then be expanded by coupling it via a backplane 440 to a plurality of input/output modules 420 which each tap into distinct RF fields 430 in order to communicate with the PLC. The short range of these RF fields allows each I/O module to interact with a distinct field, and thus there is no need for the I/O module to distinguish between fields.

RFID tags as configured today can only act as slave devices. An RFID tag can not initiate a data transfer; it can only respond to a read or write command from a reader/writer, and this behavior is written into the RFID specification.

If we were to deviate from the specification for RFID tags, it might be possible to define peer-to-peer transactions between tags. However, doing so would mean that we could no longer use off-the-shelf components to build systems, thereby losing the advantages of cost, simplicity and size. Therefore, the present invention preferably only uses RFID tags as slave devices. Moreover, a reader/writer talks to the tag by doing amplitude modulation of the RF field. It can modulate the field amplitude because it generates the field, and the tag replies to the reader/writer via load modulation. The reader/writer can detect the load modulation because it can sense the energy being drawn from the field it is generating. Peer-to-peer communications would require a different form of modulation that can be both controlled and sensed by devices that do not generate the RF field, and thus the present invention does not necessarily employ this sort of peer-to-peer communication.

As configured today, RFID tags must have a reader/writer to generate the field and control communications. They can not talk directly with each other.

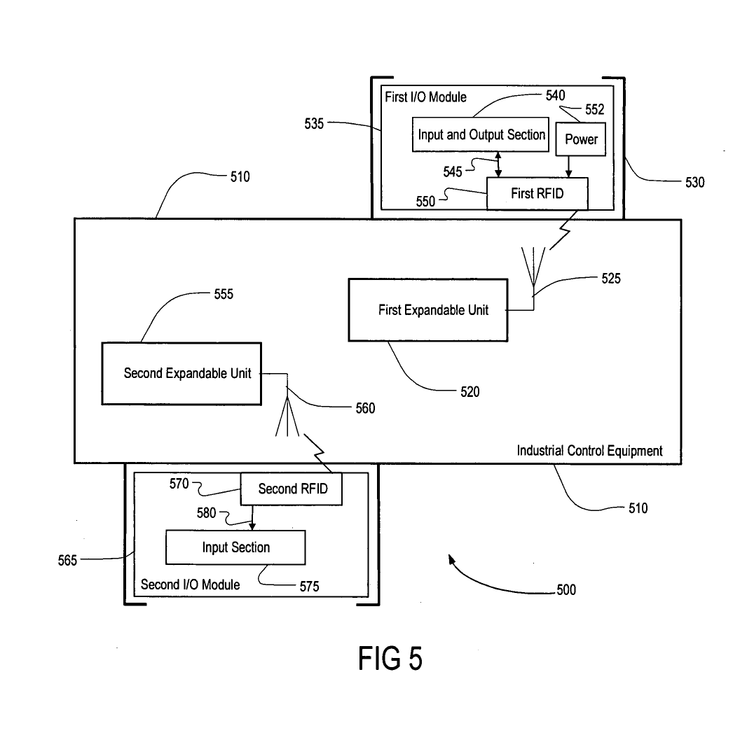

FIG. 5 shows a system 500 according to an embodiment of the present invention. Industrial control equipment 510 is expandable. In particular, the equipment 510 has a first expandable unit 520 which is equipped with an antenna 525. The industrial control equipment 510 includes attaching means 530 such as a bracket or slot for holding a first I/O module 535 which expands the first expandable unit 520. The first I/O module 535 includes an input and output section 540 that has a physical or wireless connection 545 to the first RFID 550 which is embedded in the first I/O module 535. The first I/O module 535 further includes a power supply 552 providing auxiliary power to the RFID 550 so that it can more reliably communicate with the antenna 525.

Likewise, the industrial control equipment 510 includes a second expandable unit 555 including an antenna 560. The second I/O module 565 is similar to the first I/O module 535, except that the second RFID 570 is only connected to an input section 575, and moreover the RFID 570 requires no auxiliary power supply, because it obtains sufficient power from the RF field created by the antenna 560. Moreover, there is sufficient power left over to power the input module 580 via the physical connection 580.

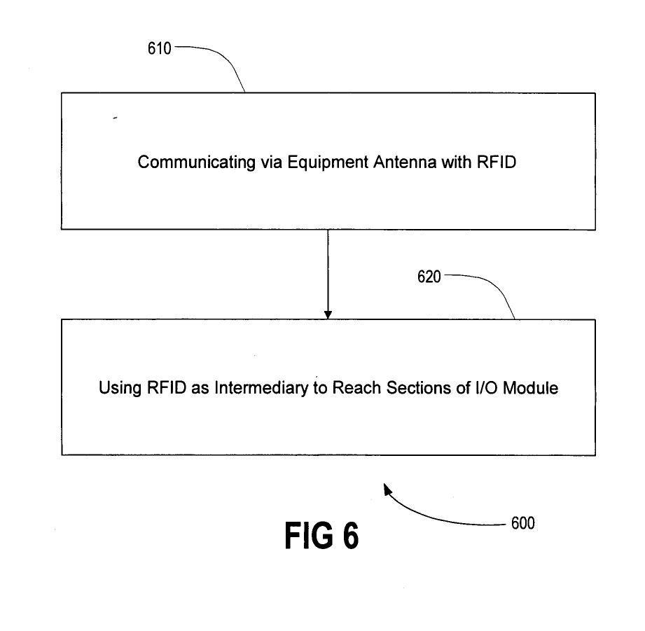

FIG. 6 simply sketches the method 610 according to an embodiment of the present invention. The first step is communicating 610 via an antenna included in the industrial control equipment, in order to reach an RFID. Then, the second step is using the RFID 620 as an intermediary to reach one or more sections of an I/O module. The system 500 of FIG. 5 illustrates one way to implement the method 600.

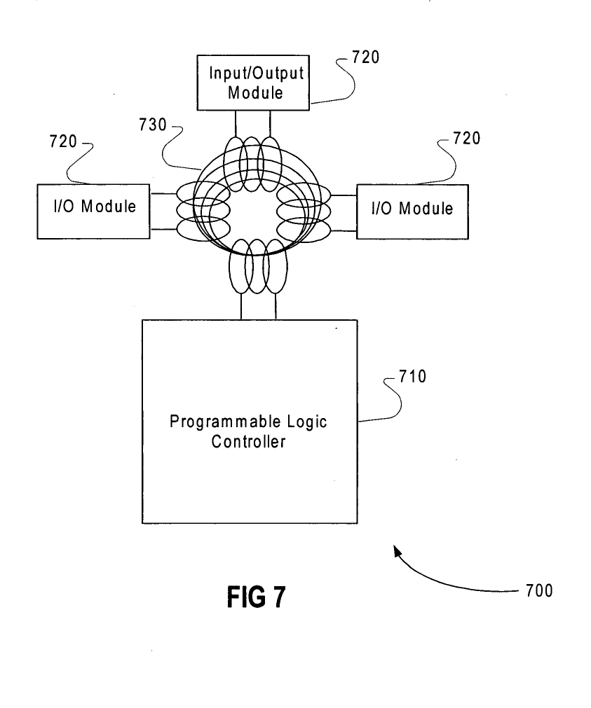

As seen in FIG. 7, a system 700 includes the industrial control equipment 710 such as a programmable logic controller (PLC). The PLC can then be expanded by coupling it to a plurality of input/output modules 720 which each tap into a single RF field 730 in order to communicate with the PLC. The I/O modules will then conveniently have unique identifiers so that each module receives or processes only the commands intended for it. For example, a command can additionally specify an alphanumeric identifier that is unique to the I/O module for which that command is intended.

Various changes may be made in the above illustrative embodiments without departing from the scope of the invention, as will be understood by those skilled in the art. It is intended that all matter contained in the above description or shown in the accompanying drawings shall be interpreted as illustrative and not in a limiting sense. The invention disclosed herein can be implemented by a variety of combinations of hardware and software, and those skilled in the art will understand that those implementations are derivable from the invention as disclosed herein.

What is claimed is:

1. A system for wirelessly coupling at least one input or output module to an industrial control equipment, comprising:
a radio frequency identification (RFID) unit located at each of the at least one input or output module for communication therewith; and
at least one antenna at the industrial control equipment, for communicating with the RFID unit,
wherein the RFID unit acts as an intermediary for communication between the control equipment and the input or output module.

2. The system of claim 1,
wherein the RFID unit is embedded within the at least one input or output module, and
wherein the RFID unit is for communicating with the at least one input or output module via a physical connection.

3. The system of claim 1,
wherein the RFID unit is embedded within the at least one input or output module, and
wherein the RFID unit is for communicating with the at least one input or output module via a wireless connection.

4. The system of claim 1,
wherein the at least one antenna at the industrial control equipment is for communicating with only one of the at least one input or output module via proximity coupling, and
wherein the at least one input or output module is physically attached to the industrial control equipment by attaching means.

5. The system of claim 1,
wherein the at least one antenna at the industrial control equipment is for communicating with a plurality of the at least one input or output module, and
wherein the plurality of the at least one input or output module have respective unique identifiers.

6. The system of claim 2, wherein the at least one RFID unit has a digital control section that feeds into the input or output module via the physical connection.

7. The system of claim 1, wherein the at least one RFID unit has a power source that is additional or alternative to power derived from the radio frequency field.

8. The system of claim 2, wherein the physical connection is also for conveying power from the radio frequency field to the input or output module.

9. The system of claim 1, wherein the at least one antenna is implemented as a set of traces on a printed wiring board.

10. The system of claim 4, wherein the attaching means comprises a slot or bracket for holding the at least one input or output module in proximity to the industrial control equipment without any electrical connection.

11. An input or output module for wirelessly coupling to an industrial control equipment, comprising:
an input section or an output section or both;
a radio frequency identification (RFID) unit for communication with the input section or the output section or both,
wherein the RFID unit acts as an intermediary for communication between the control equipment and the input section or the output section or both.

12. The input or output module of claim 11,
wherein the RFID unit is embedded within the input or output module, and
wherein the RFID unit is for communicating with the input section or the output section or both via a physical connection.

13. The input or output module of claim 11,
wherein the RFID unit is embedded within the input or output module, and
wherein the RFID unit is for communicating with the input section or the output section or both via a wireless connection.

14. The input or output module of claim 11,
wherein the RFID unit is for proximity coupling to the industrial control equipment, and
wherein the input or output module includes attaching means for attaching to the industrial control equipment.

15. The input or output module of claim 11,
wherein the input or output module has a unique identifier distinguishing the input or output module from at least one other input or output module that also communicates with an antenna at the industrial control equipment.

16. The input or output module of claim 12, wherein the at least one RFID unit has a digital control section that feeds into the input or output module via the physical connection.

17. The input or output module of claim 11, wherein the at least one RFID unit has a power source that is additional or alternative to power derived from the radio frequency field.

18. The input or output module of claim 12, wherein the physical connection is also for conveying power obtained from the radio frequency field.

19. The input or output module of claim 14, wherein the attaching means comprises a slot or bracket, or a piece fitted to a slot or bracket, for holding the input or output module in proximity to the industrial control equipment without any electrical connection.

20. A method for wirelessly coupling at least one input or output module to an industrial control equipment, comprising:
communicating, via an antenna at the industrial control equipment, with a radio frequency identification (RFID) unit,
using the RFID unit as an intermediary for communication between the industrial control equipment and the input or output module,
wherein the RFID unit is located at the input or output module for communication therewith.

21. A computer readable medium encoded with a software data structure sufficient for performing the method of claim 20.
